(19) United States
(12) Patent Application Publication
(10) Pub. No.: US 2016/0078745 A1
(43) Pub. Date: Mar. 17, 2016

(54) Proximity Sensor System

(71) Applicant: Patricia Murphy, Gaithersburg, MD (US)

(72) Inventor: Patricia Murphy, Gaithersburg, MD (US)

(21) Appl. No.: 14/839,322

(22) Filed: Aug. 28, 2015

Related U.S. Application Data
(60) Provisional application No. 62/050,253, filed on Sep. 15, 2014.

(51) Int. Cl. G08B 21/18

(52) U.S. Cl. CPC G08B 21/182

(57) ABSTRACT

A proximity sensor system configured to allow a user to identify a lost or misplaced item. The proximity sensor system includes a base unit and at least one remote unit that is disposed on a user's personal possession. The base unit includes a receiving assembly having a proximity sensor having a receiver, and each remote unit includes a transmitting assembly having a proximity sensor having a transmitter. The receiver and the transmitter are in continuous wireless communication within a set effective range. If the receiver and the transmitter exceed the set effective range, each proximity sensor is configured to transmit a signal to a microprocessor to emit an audible alert. Each remote unit has a unique audible alert, thereby allowing the user to quickly identify the specific personal possession that is lost.

### CROSS REFERENCE TO RELATED APPLICATION

This application claims the benefit of U.S. Provisional Application No. 62/050,253 filed on Sep. 15, 2014. The above identified patent application is herein incorporated by reference in its entirety to provide continuity of disclosure.

### BACKGROUND OF THE INVENTION

### Field of the Invention

The present invention relates to a tracking system. More specifically, the present invention pertains to an improved proximity sensor system, wherein a user is alerted when an item is lost or misplaced in order to help the user locate the item.

The loss of personal items, such as wallets, laptops, and cellphones, among others, is a constant source of frustration and can also be a danger in an emergency situation. These personal possessions are particularly vulnerable to theft or misplacement, which allows these personal possessions to be quickly lost without any potential leads for recovery. Various schemes have been devised for locating possessions, which demonstrate limited success by their very design.

Devices are known in the prior art that relate to proximity alarm systems for personal property. Some devices provide a proximity alarm system having a transmitter attached to an article, and a receiver having an alarm that activates when communication between the transmitter and receiver is interrupted by distance. Other devices describe a monitoring device having a transmitter coupled with a person or object and a receiver to be worn by a user, wherein the receiver is adapted to determine the distance between the receiver and transmitter and sounds an alarm if the distance exceeds a predetermined distance. These devices, however, fail to provide a base unit having a proximity sensor carried by a user. In addition, each remote unit has a proximity sensor disposed on personal possessions of the user, wherein the base unit is configured to emit a different alert for each remote unit. In this way, the user can determine which item has been misplaced based upon the alert that is produced by the proximity sensor system.

The present invention provides a proximity sensor system that is configured to allow a user to identify a specific possession that is lost, misplaced, or stolen. The proximity sensor system includes a base unit that is carried by a user and at least one remote unit that is disposed on a personal possession of the user. The base unit includes a receiving assembly and each remote unit includes a transmitting assembly. The receiving assembly includes a receiver that is in continuous wireless communication with a transmitter of a transmitting assembly within a set effective range. When the receiver and the transmitter exceed the set effective range, each proximity sensor is prompted to transmit a signal to the receiving assembly, wherein a speaker system is activated and emits an alert that is unique to a particular remote unit. In this way, the user can readily identify the specific possession that is lost to facilitate recovery of the item.

### SUMMARY OF THE INVENTION

In view of the foregoing disadvantages inherent in the known types of proximity sensor systems now present in the prior art, the present invention provides a new and improved proximity sensor system wherein the same can be utilized for emitting a unique audible alert for each remote unit in wireless connection with the base unit.

It is therefore an object of the invention to provide a new and improved proximity sensor system that has all of the advantages of the prior art and none of the disadvantages.

Another object of the present invention is to provide a new and improved proximity sensor system that includes a base unit and at least one remote unit, wherein the base unit is configured to be carried by a user and each remote unit is attached to a possession of the user.

Yet another object of the present invention is to provide a new and improved proximity sensor system wherein each remote unit includes a unique audible alert, wherein the base unit and remote unit produce the audible alert in order to allow the user to identify and locate the lost item.

Still yet another object of the present invention is to provide a new and improved proximity sensor system, wherein the base unit includes a receiving assembly having a proximity sensor with a receiver, a microprocessor, a digital storage medium, and a speaker system.

A further object of the present invention is to provide a new and improved proximity sensor system, wherein each remote unit includes a proximity sensor having a transmitter, a microprocessor, a digital storage medium, and a speaker system.

Yet a further object of the present invention is to provide a new and improved proximity sensor system, wherein the receiver and the transmitter are in continuous wireless communication within a set effective range. When the receiver and the transmitter are not within the set effective range, a unique audible alert in the remote unit and a matching unique audible alert in the base unit are triggered.

Still yet another object of the present invention is to provide a new and improved proximity sensor system wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the proximity sensor system.

FIG. 2 shows a schematic diagram of the proximity sensor system.

### DETAILED DESCRIPTION OF THE INVENTION

References are made herein to the attached drawings. Like reference numerals are used throughout the drawings to depict like or similar elements of the proximity sensor system. For the purposes of presenting a brief and clear description of the present invention, the preferred embodiment will be discussed as used for alerting a user when a possession is lost. The figures are intended for representative purposes only and should not be considered to be limiting in any respect.

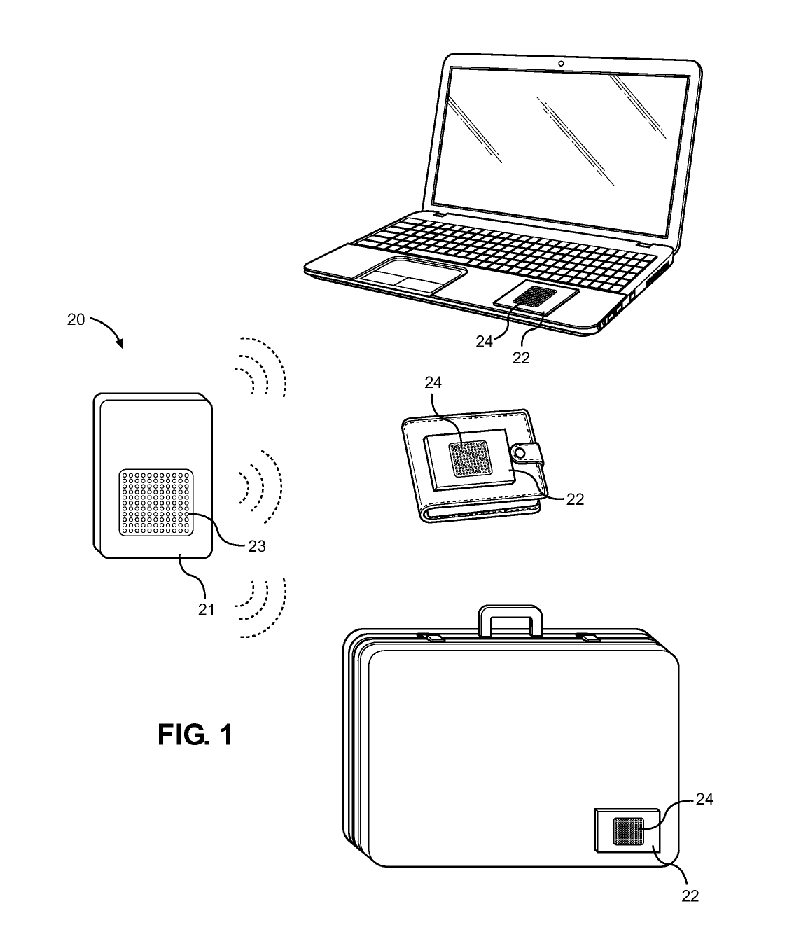

Referring now to FIG. 1, there is shown a perspective view of the proximity sensor system 20 in communication with multiple possessions. The proximity sensor system 20 includes a base unit 21 and at least one remote unit 22. The base unit 21 and the remote units 22 are in wireless communication with one another. The base unit 21 is adapted to be secured to the user or secured in a fixed location. The base unit 21 includes a housing forming an interior volume configured to support a receiving assembly 23.

Each remote unit 22 is configured to be attached on a different personal possession, such as a wallet, laptop, cell phone, or any other personal possessions. The remote units 22 can be affixed thereto via an adhesive disposed on the remote unit 22. Each remote unit 22 includes a housing forming an interior volume configured to support a transmitting assembly 24.

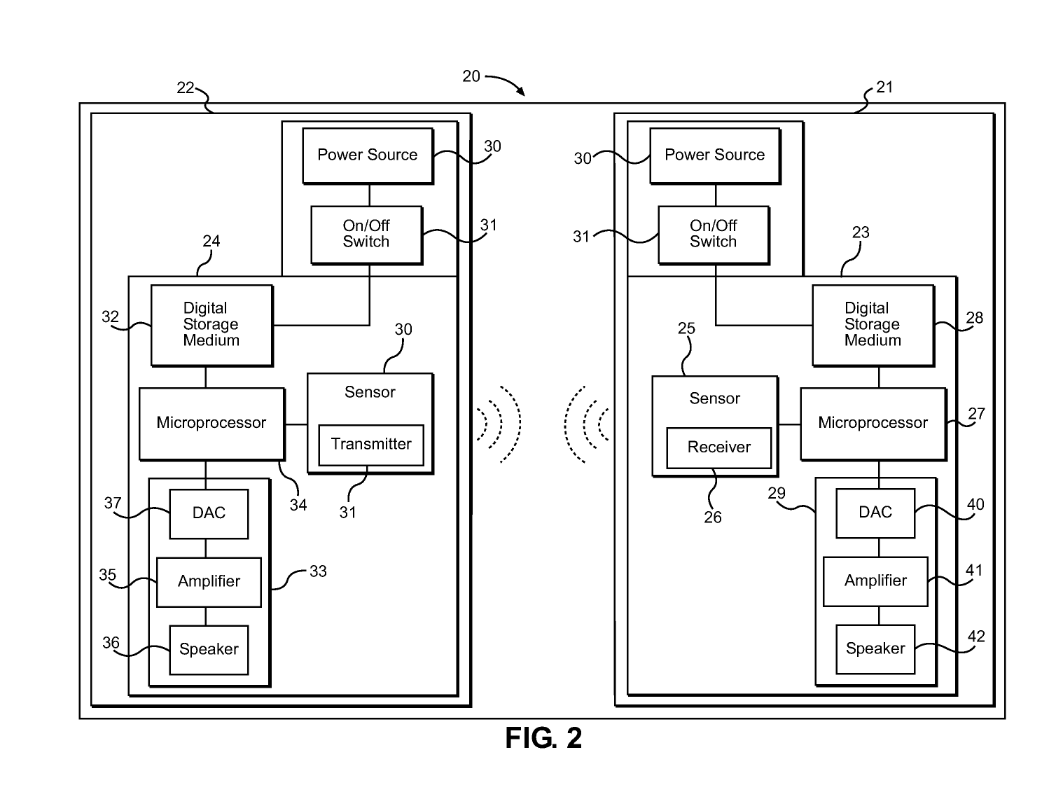

Referring now to FIG. 2, there is shown a schematic diagram of the proximity sensor system 20. The proximity sensor system 20 as aforementioned includes a base unit 21 having a receiving assembly 23 and at least one remote unit 22 having a transmitting assembly 24. The receiving assembly 23 comprises a proximity sensor 25 having a receiver 26, a microprocessor 27, a digital storage medium 28, and a speaker system 29.

Each transmitting assembly 24 comprises a proximity sensor 30 having a transmitter 31, a microprocessor 34, a digital storage medium 32, and a speaker system 33. The transmitter 31 is configured to continuously transmit a signal to the receiver 26 within a set effective range. If the proximity sensor determines that the distance between the transmitter 31 and the receiver 26 are out of the set effective range, the proximity sensor 30 of the transmitting assembly 24 transmits a signal to the microprocessor 34 of the transmitting assembly 24. Preferably, tracking possessions are done through the proximity sensors 25, 30 of the receiving assembly 23 and the transmitting assembly 24. However, it is anticipated that those of ordinary skill in the art will readily envision other means and methods of detecting a receiver and a transmitter within a set effective range. These alterations and modifications are considered to be within the scope and spirit of this present disclosure.

Upon receipt of the signal from the proximity sensor 30, the microprocessor 34 is configured to retrieve a unique digital alert file from the digital storage medium 32, which is configured to transmit a signal to the speaker system 33. Preferably, the digital storage medium 32 is a Random Access Memory (RAM) or a hard drive, however, other suitable alternatives are used in other embodiments. The speaker system includes a digital-to-analog converter (DAC) 37, an amplifier 35, and a speaker 36. The transmitted unique digital alert file is converted into an analog signal and amplified to be played through the speaker 36.

The microprocessor 34 primarily functions as a pathway between the proximity sensor 30 and the DAC 37, however the microprocessor 34 is also configured to retrieve the unique digital recording file stored within the digital storage medium 32. The unique digital alert file is transmitted to the DAC 37, which primarily functions to convert the unique digital alert file to an analog signal to drive the speaker 36.

The analog signal is transmitted to the amplifier 35, which primarily functions to intensify generally low powered analog signals from the DAC 37, to a level suitable for driving the speaker 36. Generally, an input signal to the amplifier 35 may only be a few hundred microwatts, however, the amplifier 35 can output from tens to hundreds of watts based on preference. The speaker 36 receives the output analog signal from the amplifier 35 and plays an audible alert originally stored as the unique digital alert file within the digital storage medium 32.

Each remote unit 22 includes its own unique digital alert file stored within the digital storage medium 32. Furthermore, within the receiving assembly 23, the proximity sensor 25 is configured to identify the specific remote unit 22 that is out of the set effective range. The proximity sensor 25 is configured to transmit a corresponding signal to the microprocessor 27 that is configured to indicate to the microprocessor 27 the specific remote unit 22 that is out of the set effective range. The microprocessor 27 then retrieves a matching unique digital alert file stored within the digital storage medium 28. The digital storage medium 28 of the receiving assembly 24 includes a matching unique digital alert file for each remote unit 22 within the system 20.

In this way, the unique digital alert file coordinated with a specific remote unit 22 is matched with a matching unique digital alert file within the digital storage medium 28 of the receiving assembly 24, thereby allowing the user to immediately recognize which possession he has lost based on the audio alert. For example, as illustrated in FIG. 1, there are three remote units 22 each having its own unique digital alert file. The digital storage medium 28 within the receiving assembly 23 of the base unit 21 would store matching unique digital alert files for each remote unit 22 to allow for the user to identify the specific possession he or she has lost.

Much like the transmitting assembly 24, the microprocessor 27, in the receiving assembly 23, transmits the matching unique digital alert file to the speaker system 29, wherein the speaker system 29 comprises a DAC 40, an amplifier 41, and a speaker 42. The matching unique digital alert file is converted into an analog signal by the DAC 40 to drive the speaker 42. The analog signal is transmitted to the amplifier 41 to a level suitable for driving the speaker 42. The speaker 42 receives the output analog signal from the amplifier 41 and plays the matching audible alert originally stored as the matching digital alert file in the digital storage medium 27.

Appropriate threshold conditions for triggering the proximity sensors 25, 30 may also be established. For example, the set effective range can be configured to a preferable distance. A set effective range that is too narrowly focused may detect extraneous movements. However, too large of a set effective range will not activate the proximity sensors 25, 30 when required. It is not desired in this present disclosure to limit the set effective range of the proximity sensors 25, 30. However, it is desired to disclose and claim the proximity sensors 25, 30 for the results and advantages described herein. It is contemplated that the set effective range is readily discernible to those of ordinary skill in the art with the present disclosure before them and these modifications and alterations are deemed to be within the scope of the invention embodiments described herein.

Furthermore, the transmitting assembly 24 of each remote unit 22 and the receiving assembly 23 of the base unit 21 each further comprise a power source 30 configured to provide electrical power to the transmitting assembly 24 or the receiving assembly 23. Each power source 30 is electrically connected to an on/off switch 31 configured to activate and deactivate electrical communication between the power source 30 and the receiving assembly 23 or the transmitting assembly 24. Preferably each power source 30 is a battery, however, other alternatives are suitable. In addition, each on/off switch 31 is preferably a rocker switch, however, a depressible activation button, a toggle switch, or other suitable switches are used in alternative embodiments.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A proximity sensor system, comprising:
a base unit and at least one remote unit adapted to be affixed to a personal possession of a user, wherein said at least one remote unit is in wireless communication with said base unit;
each of said remote unit having a unique audible alert;
wherein said base unit is configured to produce said unique audible alert and said remote unit is configured to produce said unique alert when said base unit and said at least one remote unit are out of a set effective range.

2) The proximity sensor system of claim 1, wherein:
said base unit includes a receiving assembly having a receiver, a microprocessor, a digital storage medium, and a speaker system;
wherein said receiving assembly is electrically connected to a power source;
each said remote unit includes a transmitting assembly having a proximity sensor including a transmitter, a microprocessor, a digital storage medium, and a speaker system;
wherein said transmitting assembly is electrically connected to a power source;

3) The proximity sensor system of claim 2, wherein:
said receiver and said transmitter are configured to be in wireless communication within said set effective range;
wherein each said proximity sensor is configured to transmit a signal to each said microprocessor when said receiver and said transmitter are out of a said set effective range.

4) The proximity sensor system of claim 2, wherein;
said microprocessor of said transmitting assembly is configured to retrieve said unique digital alert file from said digital storage medium and transmit said unique digital alert file to said speaker system configured to activate said speaker system;
wherein said microprocessor of said receiving assembly is configured to retrieve said matching unique digital alert file from said digital storage medium and transmit said matching unique digital alert file to said speaker system configured to drive said speaker system.

5) The proximity sensor system of claim 4, wherein said digital storage medium of said receiving assembly comprises each said matching unique digital alert file for each said remote unit.

6) The proximity sensor system of claim 2, wherein;
each said speaker system includes a digital-to-analog converter, an amplifier, and a speaker;
wherein said speaker of said transmitting assembly is configured to play said unique digital alert file;
wherein said speaker of said receiving assembly is configured to play said matching unique digital alert file.

7) The proximity sensor system of claim 1, wherein said receiving assembly further comprising an on/off switch configured to activate and deactivate electric communication between said power source and said transmitting assembly.

8) The proximity sensor system of claim 1, wherein said transmitting assembly further comprising an on/off switch configured to activate and deactivate electric communication between said power source and said transmitting assembly.

9) The proximity sensor system of claim 1, wherein said base unit further includes a housing forming an interior volume configured to support said receiving assembly.

10) The proximity sensor system of claim 1, wherein each said remote unit further includes a housing forming an interior volume configured to support said transmitting assembly.

11) The proximity sensor system of claim 2, wherein each said power source includes a battery.
